(19) United States
(12) Patent Application Publication
(10) Pub. No.: US 2003/0149861 A1
(43) Pub. Date: Aug. 7, 2003

(54) Stalling instructions in a pipelined microprocessor

(76) Inventor: Matthew Becker, Maxwell AFB, AL (US)

Correspondence Address: John C. Alemanni, Kilpatrick Stockton LLP, 1001 West Fourth Street, Winston Salem, NC, 27101-2400, US

(21) Appl. No.: 10/100,101

(22) Filed: Mar. 18, 2002

Related U.S. Application Data
(63) Continuation of application No. 10/007,492, filed on Feb. 6, 2002.

(51) Int. Cl. G06F 9/30

(52) U.S. Cl. 712/214

(57) ABSTRACT

Methods and systems are disclosed for indicating microprocessor resources are limited. One method subtracts a current value of a pointer from a maximum value of the pointer and compares to a desired value. A stall is asserted when the desired value is achieved. Another method advances instructions along a pipeline, with the pipeline having a minimum amount of open space. The minimum amount of open space is subtracted from a current amount of open space within the pipeline, and this result is compared to a desired value. A stall is asserted when the desired value is achieved.

### BACKGROUND OF THE INVENTION

1. Field of the Invention

This invention generally relates to computer systems and, more particularly, to circuits and methods for stalling instructions in a pipelined microprocessor.

2. Description of the Related Art

A microprocessor instruction pipeline utilizes a feedback mechanism to indicate machine resources are limited. As instructions stream along the pipeline and are executed by the microprocessor, a machine resource may become limited and unable to accept/execute more instructions. When this resource becomes limited, the machine, and the pipeline advancing instructions to the microprocessor, is often stalled until the resource is free. The pipeline, therefore, often has a feedback mechanism to learn of limited resources and to initiate a stall.

The prior art feedback mechanism utilizes two pointers when initiating a pipeline stall. The prior art compares the values of two pointers, a write pointer and a retire pointer. If there is a space between the write and the retire pointers, then a resource is open and available. If no space exists between the write and the retire pointers, no more instructions can be fetched and executed, and a pipeline stall may be required. Because the prior art feedback mechanism utilizes two pointers, determining the space between these two pointers requires multiple operations. The value of each pointer, for example, must first be updated. The updated values are then subtracted, and the result is compared to some value (most commonly, zero).

The multiple pointers of the prior art feedback mechanism are inefficient and slow. The multiple operations that are required, when updating, subtracting, and comparing the two pointers, consume unnecessary power and hinder the design of lower-powered microprocessors and machines. The multiple operations also contribute to heat management problems within the microprocessor. Multiple operations are also slow to calculate. The prior art feedback mechanism is thus an inefficient and slow implementation of asserting a stall.

There is, accordingly, a need in the art for methods and circuits that stall pipelined microprocessors, that require less operations when determining a stall, that determine a stall faster than the prior art.

### BRIEF SUMMARY OF THE INVENTION

The aforementioned problems are minimized by the present invention. The present invention describes circuits and methods for stalling the pipeline of a microprocessor. These methods and circuits use a single pointer to determine a stall condition. Because a single pointer is used, the present invention requires less operations, is faster, and consumes less power than the prior art.

The present invention discloses new methods and new circuit architectures for a pipeline feedback. The methods and circuits of the present invention need only update the value of a single pointer. As instructions advance and retire within the pipeline, the single pointer indicates the amount of space within the pipeline. When the value of this single pointer reaches the amount of desired space, the pipeline cannot accept another instruction. The machine, therefore, is out of resources and a stall is asserted.

### BRIEF DESCRIPTION OF THE SEVERAL VIEWS OF THE DRAWINGS

These and other features, aspects, and advantages of the present invention are better understood when the following Detailed Description of the Invention is read with reference to the accompanying drawings, wherein:

FIG. 1 depicts a possible operating environment for one embodiment of the present invention;

FIG. 2 is a block diagram of a microprocessor;

FIGS. 3 and 4 are block diagrams of a nine-stage pipeline;

FIG. 5 is a circuit schematic of one embodiment of the present invention;

FIG. 6 is a flowchart of a method for stalling instructions to a pipelined microprocessor; and

FIG. 7 is a circuit schematic of an alternative embodiment of the present invention.

### DETAILED DESCRIPTION OF THE INVENTION

One embodiment of the present invention comprises a method for determining when microprocessor resources are limited. This method subtracts a current value of a pointer from a maximum value of the pointer and produces a result. This result is compared to a desired value. A stall is asserted when the desired value is achieved.

Another embodiment advances instructions along a pipeline, with the pipeline having a minimum amount of open space. The minimum amount of open space is subtracted from a current amount of open space within the pipeline, and a result is produced. This result is compared to a desired value. When the desired value is achieved, that is when the desired value equals the result, a stall condition is asserted.

A further embodiment advances instructions along a staged pipeline and establishes a single pointer. This single pointer indicates the amount of open space within the pipeline. A stall condition is asserted when the single pointer indicates resources are limited.

Yet another embodiment of the present invention includes advancing instructions along a pipeline, with the pipeline having a predetermined number of instructions per stage in the pipeline. The method detects an overlap of a staged instruction by an advancing instruction and asserts a stall condition to indicate resources are limited. The advancing instructions are then stalled, permitting the limited resources to recover.

Another embodiment advances instructions along a staged pipeline. The pipeline has a predetermined number of instructions in the pipeline, and the pipeline has a predetermined number of instructions per stage in the pipeline. A stage of instructions are sent for execution and, as each instruction is retired, an open space is created within the pipeline. The method permits a predetermined minimum number of open spaces within the pipeline. A stall condition is asserted when at least one of i) the number of open spaces within the pipeline equals the permitted minimum number of open spaces within the pipeline, and ii) the number of open spaces within the pipeline is less than the permitted minimum number of open spaces within the pipeline.

In a further embodiment, which advances instructions along a staged pipeline, as an instruction is retired, an open space is created within the pipeline. A single pointer indicates the number of open spaces within the pipeline, and a stall condition is asserted when the single pointer indicates resources are limited.

In another embodiment of the present invention, which advances instructions along a staged pipeline, the pipeline contains a predetermined maximum number of instructions, and the pipeline has a predetermined number of instructions per stage. As an instruction is retired, an open space within the pipeline is created. A single pointer indicates the available spaces within the pipeline. The single pointer has a value established by subtracting a predetermined minimum number of open spaces within the pipeline from the current number of open spaces within the pipeline. A stall condition is asserted when the single pointer has a value of zero. The zero value of the single pointer indicates resources are limited. The predetermined minimum number of open spaces within the pipeline may be chosen during an initialization procedure. The predetermined minimum number of open spaces may be initialized as an amount of desired space within the pipeline (instead of the amount of actual space). Any comparison against zero (0), or the easiest number circuit-wise to compare against, may be chosen regardless of any given desired comparison point.

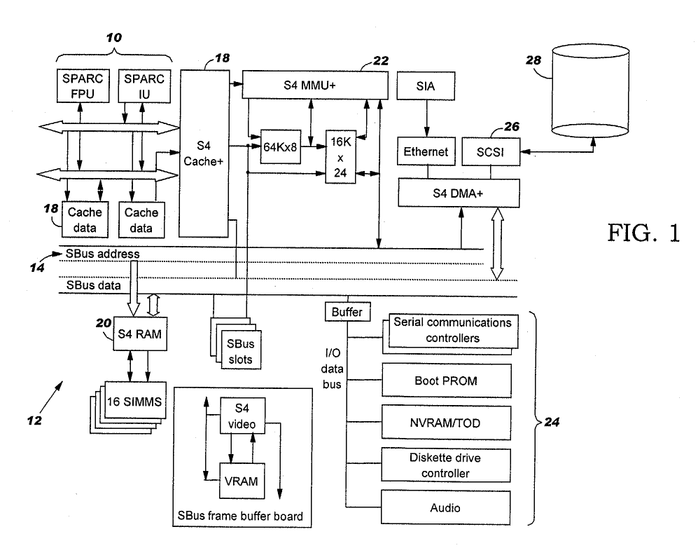

FIG. 1 depicts a possible operating environment for one embodiment of the present invention. FIG. 1 illustrates a microprocessor 10 operating within a computer system 12. The computer system 12 includes a bus 14 communicating information between the microprocessor 10, cache memory 18, Random Access Memory 20, a Memory Management Unit 22, one or more input/output controller chips 24, and a Small Computer System Interface (SCSI) controller 26. The SCSI controller 26 interfaces with SCSI devices, such as mass storage hard disk drive 28. Although FIG. 1 describes the general configuration of computer hardware in a computer system, those of ordinary skill in the art understand that the present invention described in this patent is not limited to any particular computer system or computer hardware.

Those of ordinary skill in the art also understand the present invention is not limited to any particular manufacturer's microprocessor design. Sun Microsystems, for example, designs and manufactures high-end 64-bit and 32-bit microprocessors for networking and intensive computer needs (Sun Microsystems, Inc., 901 San Antonio Road, Palo Alto Calif. 94303, www.sun.com). Advanced Micro Devices (Advanced Micro Devices, Inc., One AMD Place, P.O. Box 3453, Sunnyvale, Calif. 94088-3453, 408.732.2400, 800.538.8450, www.amd.com) and Intel (Intel Corporation, 2200 Mission College Blvd., Santa Clara, Calif. 95052-8119, 408.765.8080, www.intel.com) also manufacture various families of microprocessors. Other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). While only one microprocessor is shown, those skilled in the art also recognize the present invention is applicable to computer systems utilizing multiple processors.

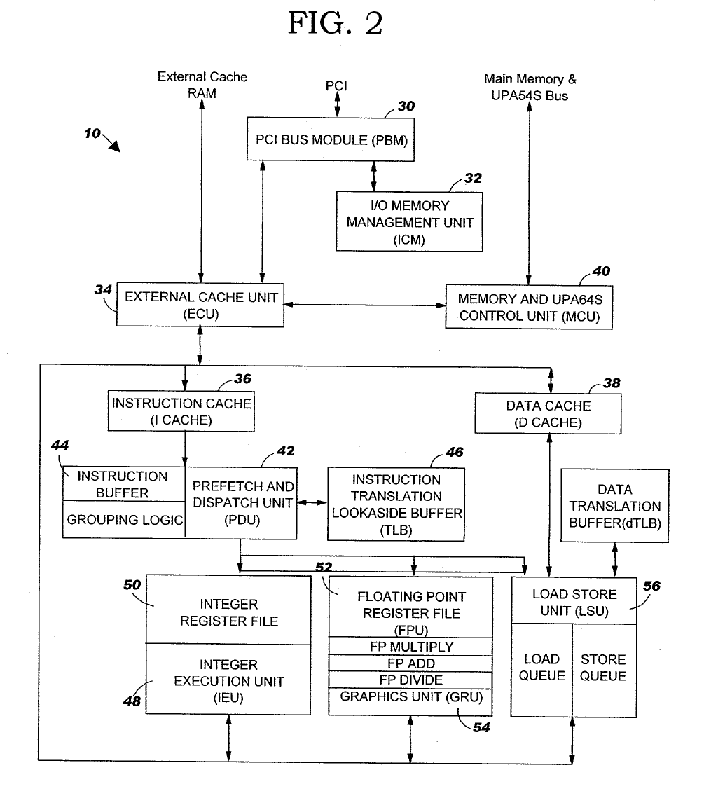

FIG. 2 is a block diagram of the microprocessor 10. Because, however, the terms and concepts of art in microprocessor design are readily known those of ordinary skill, the microprocessor 10 shown in FIG. 2 is only briefly described. The microprocessor 10 uses a PCI bus module 30 to interface with a PCI bus (not shown for simplicity). An Input/Output Memory Management Unit (IOM) 32 performs address translations, and an External Cache Unit (ECU) 34 manages the use of external cache (not shown for simplicity) for instruction cache 36 and for data cache 38. A Memory Control Unit (MCU) 40 manages transactions to dynamic random access memory (DRAM) and to other subsystems. A Prefetch and Dispatch Unit (PDU) 42 fetches an instruction before the instruction is needed. Prefetching instructions helps ensure the microprocessor does not “starve” for instructions and slow the execution of instructions. The Prefetching and Dispatch Unit (PDU) 42 may even attempt to predict what instructions are coming in the pipeline, thus, further speeding the execution of instructions. A fetched instruction is stored in an instruction buffer 44. An Instruction Translation Lookaside Buffer (ITLB) 46 provides mapping between virtual addresses and physical addresses. An Integer Execution Unit (IEU) 48, along with an Integer Register File 50, supports a multi-cycle integer multiplier and a multi-cycle integer divider. A Floating Point Unit (FPU) 52 issues and executes one or more floating point instructions per cycle. A Graphics Unit (GRU) 54 provides graphics instructions for image, audio, and video processing. A Load/Store Unit (LSU) 56 generates virtual addresses for the loading and for the storing of information.

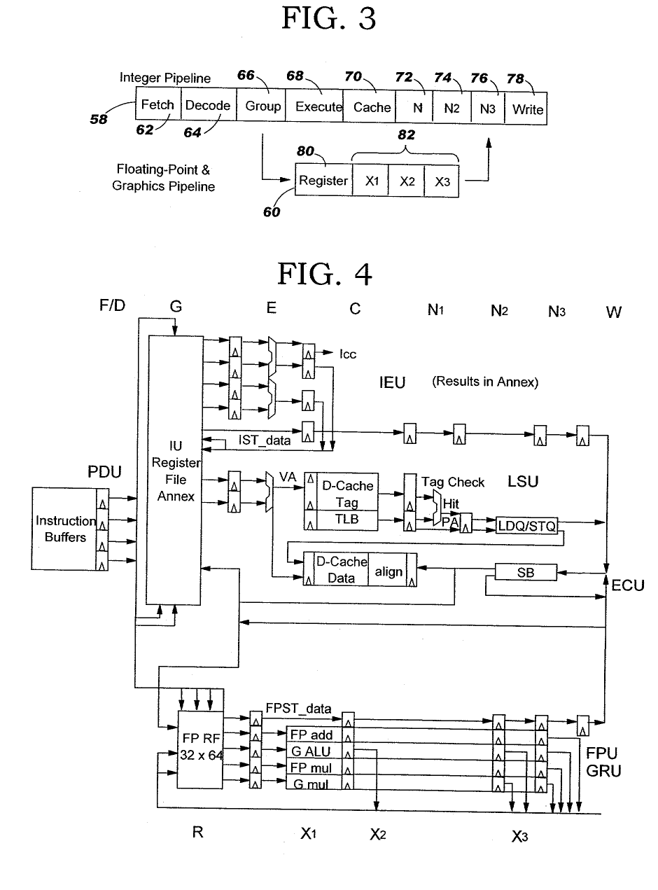

FIGS. 3 and 4 are block diagrams of a nine-stage pipeline. FIG. 3 is a simplified block diagram showing an integer pipeline 58 and a floating-point pipeline 60. FIG. 4 is a detailed block diagram of the pipeline stages. Those of ordinary skill in the art recognize that resources are limited in the register file and in the number of instructions allowed in the pipeline. These are the resources that may require the pipeline to be stalled. Those of ordinary skill in the art also recognize that other resources may be constrained. As FIGS. 3 and 4 show, an instruction to the microprocessor (shown as reference numeral 10 in FIGS. 1 and 2) advances through the integer pipeline 58 and the floating-point pipeline 60 in one of these stages. Because the general concept of a pipelined microprocessor has been known for over ten (10) years, the stages are only briefly described. The nine stages of the integer pipeline 58 include a fetch stage 62, a decode stage 64, a grouping stage 66, an execution stage 68, a cache access stage 70, a miss/hit stage 72, an executed floating point instruction stage 74, a trap stage 76, and a write stage 78. The floating-point pipeline 60 has a register stage 80 and execution stages X₁, X₂, and X₃ (shown as reference numeral 82). The instruction is fetched from the instruction cache unit (shown as reference numeral 36 in FIG. 3) and placed in the instruction buffer (shown as reference numeral 44 in FIG. 2). The decode stage 64 retrieves a fetched instruction stored in the instruction buffer, pre-decodes the fetched instruction, and then return stores pre-decoded bits in the instruction buffer. The grouping stage 66 receives, groups, and dispatches one or more valid instructions per cycle.

After an instruction has been fetched, decoded, and grouped, the instruction is executed at the execution stage 68. The floating-point pipeline 60, at the register stage 80, accesses a floating point register file, further decodes instructions, and selects bypasses for current instructions. The cache stage 70 sends virtual addresses of memory operations to RAM to determine hits and misses in the data cache. The X₁ stage 82 of the floating-point pipeline 60 starts the execution of floating-point and graphics instructions.

Data cache miss/hits are determined during the N₁ stage 72. If a load misses the data cache, the load enters a load buffer. The physical address of a store is also sent to a store buffer during the N₁ stage 72. If store data is not immediately available, store addresses and data parts are decoupled and separately sent to the store buffer. This separation helps avoid pipeline stalls when store data is not immediately available. The symmetrical X₂ stage 82 in the floating-point pipeline 60 continues executing floating point and graphics instructions.

Most floating-point instructions complete execution in the N₂ stage 74. Once the floating-point instructions complete execution, data may be bypassed to other stages or forwarded to a data portion of the store buffer. All results, whether integer or floating-point, are written to register files in the write stage 78. All actions performed during the write stage 78 are irreversible and considered terminated. FIGS. 3 and 4 show that resources are limited in the register file and in the number of instructions allowed in the pipeline. These resources may require the pipeline to be stalled. Those of ordinary skill in the art also recognize that other resources may be constrained.

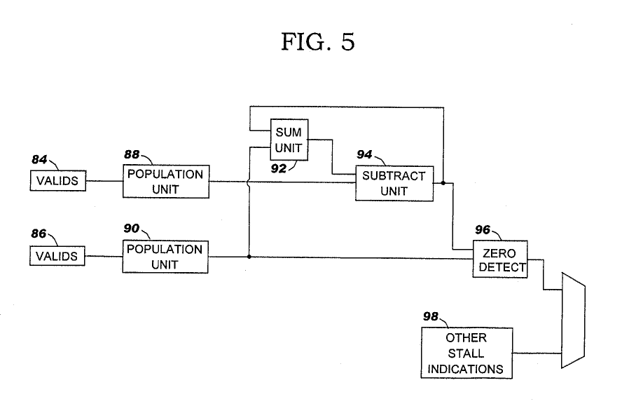

FIG. 5 is a circuit schematic of one embodiment of the present invention. FIG. 5 demonstrates that a recirculating stall space pointer gets updated by two (2) sets of incoming valids. A first set of returning valids 84 and a second set of valids 86 are sparse one hot signals. The first set of returning valids 84 and the second set of valids 86 are each respectively population-counted by a first population unit 88 and by a second population unit 90. An output of the first population unit 88 and of the second population unit 90 are each feedback looped through a summing unit 92 and a subtracting unit 94 to calculate a current value for the recirculating stall space pointer. The current value for the recirculating stall space pointer is then analyzed by a zero detection unit 96. If the recirculating stall space pointer has a value of zero (0), then a stall condition is asserted to stall the advancing instructions in the pipeline and to allow resources to catch-up. The recirculating stall space pointer may also be combined with other types or indications of stall 98 to produce an overall stall condition.

The embodiment shown in FIG. 5 may limit the number of instructions within the pipeline and the number of active registers used. While the number of instructions within the pipeline may be any number that suits design criteria, the preferred embodiment limits the pipeline to 128 instructions. The present invention tracks the last instructions coming through the pipeline and the instructions to be written and helps ensure these instructions do not overlap. Notice the instructions could overlap by zero (0) or by any other number that suits design criteria. In the preferred embodiment, all instructions within a pipeline stage are sent to the execution units. So, if the pipeline stage includes eight instructions per pipeline stage, the preferred embodiment does not assert a “middle stall” and, for example, only execute four of the eight instructions. There must, therefore, be eight open spaces within the pipeline to avoid asserting a stall condition.

As FIG. 5 then illustrates, the recirculating stall space pointer tracks or indicates the number of open instruction spaces within the pipeline. The recirculating stall space pointer has a value determined by subtracting the minimum number of open spaces within the pipeline from the total number of open instruction spaces within the pipeline. If the recirculating stall space pointer has a value of zero (0), then an overlap has occurred and a stall condition is asserted. The preferred embodiment, therefore, subtracts the desired minimum of eight (8) open spaces within the pipeline from the 128 open spaces at start-up. The recirculating stall space pointer thus has an initial value of 120. The recirculating stall space pointer is then moved, or revalued, up and down based upon the number of incoming instructions. An incoming instruction would move the recirculating stall space pointer to 119 open spaces, while a retiring instruction would move the recirculating stall space pointer to 120. When the recirculating stall space pointer has a value of zero (0), the pipeline has no space for incoming instructions and a stall condition is asserted.

The recirculating stall space pointer is a much faster calculation. Whereas two pointers, a write pointer and a retire pointer, are usually tracked, the present invention tracks only one pointer. The present invention updates a single pointer by tracking the amount of space allowed within the pipeline. When this single pointer reaches zero (0), the machine is out of resources and a stall is asserted. Because the present invention tracks a single pointer, and because detecting zero (0) is faster than comparing two separate pointers, the present invention is a faster and more efficient indicator of limited machine resources.

The recirculating stall space pointer is also fully customable. The preferred embodiment has 128 instructions in the pipeline, and eight instructions per stage. Circuit and system designers, however, could establish a predetermined number of instructions within the pipeline and a predetermined number of instructions per stage in the pipeline. Even the minimum number of open spaces within the pipeline could be predetermined. These parameters, for example, could be established during a power-up of the computer system.

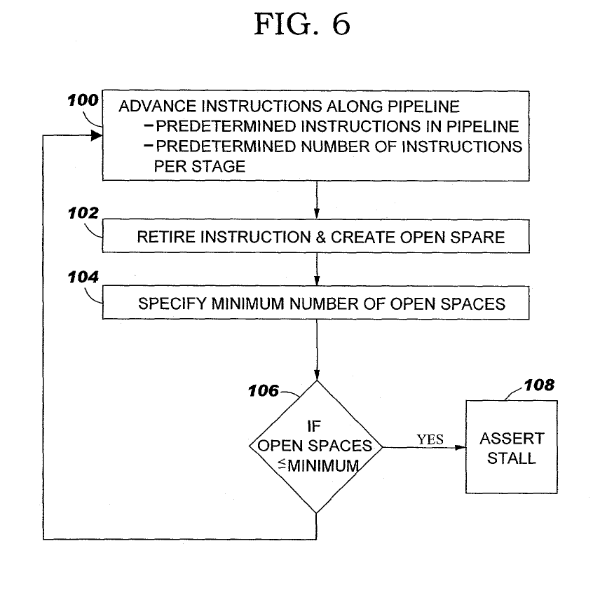

FIG. 6 is a flowchart of a method for stalling instructions to a pipelined microprocessor. The pipeline advances instructions along a staged pipeline (Block 100). The pipeline has a predetermined number of instructions in the pipeline, and the pipeline has a predetermined number of instructions per stage in the pipeline. As an instruction is retired, an open instruction space is created within the pipeline (Block 102). The method allows a minimum number of open spaces within the pipeline to be determined or specified (Block 104). If the number of open spaces within the pipeline is less than or equal to the minimum number of open spaces within the pipeline (Block 106), a stall condition is asserted (Block 108).

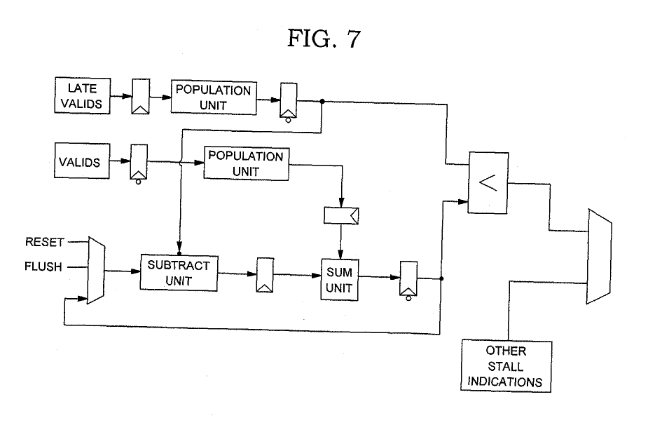

FIG. 7 is a circuit schematic of an alternative embodiment of the present invention. Although the overall method is similar, circuit optimizations may be made if either of the updates arrive early. FIG. 7 shows that late arriving valids in an upper update path are directly used in a comparison stage. These late arriving valids also enter the recirculating stall space loop for the next cycle. This improves the circuit speed possible for late arriving inputs. This calculated stall, as before, is then combined with other indications of stall to produce an overall stall.

While this invention has been described with respect to various features, aspects, and embodiments, those skilled and unskilled in the art will recognize the invention is not so limited. Other variations, modifications, and alternative embodiments may be made without departing from the spirit and scope of the following claims. This invention, for example, is not limited to a microprocessor. The present invention is applicable to any system requiring a signal based on two related pointers.

What is claimed is:

1. A method, comprising:
subtracting a current value of a pointer from a maximum value of the pointer;
comparing to a desired value; and
asserting a stall when the desired value is achieved.

2. A method according to claim 1, further comprising initializing the desired value of the pointer.

3. A method according to claim 1, further comprising initializing the desired value of the pointer to an integer value.

4. A method according to claim 1, further comprising initializing the desired value of the pointer to zero.

5. A method, comprising:
advancing instructions along a pipeline, the pipeline having a minimum amount of open space;
subtracting the minimum amount of open space from a current amount of open space within the pipeline;
comparing to a desired value; and
asserting a stall when the desired value is achieved.

6. A method according to claim 5, further comprising initializing the desired value.

7. A method according to claim 5, further comprising initializing the desired value to an integer value.

8. A method according to claim 5, further comprising initializing the desired value to zero.

9. A method according to claim 5, wherein the step of asserting the stall comprises asserting an instruction stall.

10. A method according to claim 5, wherein the step of asserting the stall comprises asserting a register stall.

11. A method according to claim 5, wherein the step of comparing to the desired value comprises comparing to the desired value each clock cycle.

12. A method according to claim 5, further comprising increasing the current amount of open space as an instruction is retired.

13. A method according to claim 5, further comprising decreasing the current amount of open space for an incoming instruction.

14. A method, comprising:
advancing instructions along a staged pipeline;
establishing a single pointer to indicate the amount of open space within the pipeline; and
asserting a stall condition when the single pointer indicates resources are limited.

15. A method according to claim 14, further comprising establishing a minimum number of open spaces within the pipeline.

16. A method according to claim 15, wherein the minimum number of open spaces corresponds to the number of instructions per stage.

17. A method according to claim 14, further comprising establishing a maximum amount of open space within the pipeline.

18. A method according to claim 14, further comprising comparing the value of the single pointer to a desired value.
